(19) United States
(12) Patent Application Publication
(10) Pub. No.: US 2014/0254084 A1
(43) Pub. Date: Sep. 11, 2014

(54) Multiprocessor Computing Apparatus with Wireless Interconnect for Communication among its Components

(71) Applicant: Sureshchandra B. Patel, Toronto (CA)

(72) Inventor: Sureshchandra B. Patel, Toronto (CA)

(21) Appl. No.: 14/202,306

(22) Filed: Mar. 10, 2014

Related U.S. Application Data
(60) Provisional application No. 61/802,398, filed on Mar. 16, 2013.

(30) Foreign Application Priority Data
Mar. 11, 2013 (CA) 2809725

(51) Int. Cl. G06F 1/16; G06F 13/40

(52) U.S. Cl. CPC G06F 1/16; G06F 13/4022
USPC 361/679.31

(57) ABSTRACT

A fan less Multiprocessor Computing Apparatus (MCA) is housed in a metallic Enclosure (ME) that acts as an heat sink and provides extended surface area for heat dissipation. The ME also acts as an electro-magnetic-Shield that provides immunity from Electro-Magnetic-Interference (EMI) from external stray magnetic fields to wireless communications among components of MCA. The Wireless Interconnect (WLI) can use whole range of radio, microwave, and optical frequencies involving transceivers and antennas. Printed Circuit Boards of MCA are mounted on inside of metallic surfaces of ME of any required size and shape. MEs are filled with vacuum or clean air without any suspended particles for efficient and reliable communications. Electro-magnetically shielded and sealed MEs housing MCAs are made dust and water proof so that they can be placed under water in a sea or a river, particularly MCAs constituting large data/cloud centres.

### TECHNICAL FIELD

The present invention relates to a Multiprocessor Computing Apparatus (MCA) with wireless interconnect for communication among its components comprising each of the multiprocessors and shared resources such as banks of shared memory, interface circuits of peripheral component and inputs/outputs. The invention in general relates to any apparatus or equipment or device with wireless interconnect for communication among or inter sub-functional and/or functional units implemented, in component Integrated Circuits (ICs) and using discrete electronics components for other related circuits.

### BACKGROUND OF THE INVENTION

Switching speed of transistors and diodes improves over each technology generation of shrinking geometries and increasing integration density or scaling of Complementary-Metal-Oxide-Semiconductor (CMOS) Integrated Circuits (ICs). As per International Technology Roadmap for Semiconductor (ITRS) for the year 2010, the cut-off frequency of switching is expected to be of the order of about 600 GHz in 16 nm CMOS technology leading to the availability of hundreds of GHz bandwidth in the near future. ICs are networks/circuits in packages interconnecting thousands or millions or billions of discrete electronic components like transistors, diodes, resistors, capacitors etc. depending on Small Scale Integration (SSI) or Large Scale Integration (LSI) or Very Large Scale Integration (VLSI). However, increasing clock frequency for operation of ICs in a push for faster computation, power lost as heat in switching components like transistors, diodes, and Metallic Interconnects (MIs) due to skin effect, and Resistance-Capacitance (RC) time constants propagation delays in MIs connecting discrete electronic components increases particularly in LSI and VLSI degrading performance. Increasing clock frequency for the operation of digital ICs, increases the self inductance (L) and therefore self reactance (X_{L}=2πfL) of MIs. However, central core portion of the MI experience greater L and 2πfL pushing current to flow through the outer periphery of MI known as the skin effect. Because of the skin effect, pulsating current flowing through MIs experience increased Impedance (R+jX_{L}), and therefore increased I²R losses as heat in MIs. Modern computing apparatus is composed of various ICs mounted on Mother Printed Circuit Board and if required additional add on Printed Circuit Boards (PCBs). PCBs usually of plastic material printed with traces of copper connecting various discrete components and pins of ICs, wherein copper traces are narrow, densely laid for communication of data, addresses, and control signals, and power supply to and from various ICs. Again, increasing frequency of operation of ICs in a push for faster computation, RC time constants of, power lost as heat due to skin effect in, and cross talk called Inter Symbol Interference (ISI) due to parasitic inductances (L) among, long usually copper MIs connecting ICs increases degrading performance of an apparatus or a device or a system. Therefore, global clock frequency and data rates within/intra and among/inter IC chips are limited to below about 6 GHz. Scaling of MIs along with scaling of ICs in LSI/VLSI has degraded the performance of the LSI/VLSI in terms of operating clock frequency and data rates, and power consumption.

With the increasing integration density and cut-off switching frequency of transistors in CMOS ICs, the MIs technology is emerging as the major bottleneck to the performance improvement of VLSI such as System-on-Chip (SoC), System-in-Package (SiP), and Network-on-Chip (NoC) etc. This performance bottleneck is due to the global interconnection delays becoming significantly larger than the gate switching delays. Carbon nanomaterials based Carbon Nano-Tubes (CNTs) and Graphene Nano-Ribbons (GNRs) are emerging as next-generation interconnect technology referred to as Carbon Interconnects (CIs) that has the potential to resolve the most problems of MIs. However, according to ITRS, only material innovations like CNTs and GNRs will lead to a brick wall that can only be overcome by radically different interconnect architectures based on other forms of technology scaling.

The MCA has evolved to have as many number of banks of shared memory as number of processors. This is in order to facilitate simultaneous access of different banks of shared memory by different processors for reducing latency and contention for shared memory. This approach has followed from FIG. 4 of the Best Possible Parallel Computer Architecture (BPPCA) claimed in the technologically disruptive U.S. Pat. No. 7,788,051 and Canadian Patent #2564625 titled “Method and Apparatus for Parallel Loadflow Computation for Electrical Power System”, where each processor has been shown to connect to the box of shared memory leading to the idea that shared memory can be divided into as many memory banks as the number of processors, and then provide interconnect to increase shared memory bandwidth. It also follows from the original statement in the U.S. Pat. No. 7,788,051 and Canadian Patent #2564625 that possibly using multiple port shared memory, and the number of ports are as many as number of processors as per FIG. 4. Canadian Patent #2564625 provides figures each completely contained in a single A4 size paper as originally provided by this inventor. So far the trend has been to put as many processors along with their private memories and banks of shared memory on a single chip with MIs and associated switches constituting what is called System On Chip (SOC). However, this arrangement can introduce substantial delays in accessing data from a bank of shared memory located at the other end across the chip by a processor at the one end, because data has to take several ‘hops’ through MIs and associated switches.

Parallel Gauss-Seidel-Patel Loadflow (PGSPL) when implemented on BPPCA claimed in U.S. Pat. No. 7,788,051 and Canadian Patent #2564625 titled “Method and Apparatus for Parallel Loadflow Computation for Electrical Power System”, ignoring all communication delays was estimated to speed-up by a factor of 10 for the first time in the parallel computation history, and that marked the beginning of the new era of computer technology. Historically, parallel computing produced speed-up at the most about 3-times. Any attempt to further speed-up by a factor about more than 3 was not successful even by increasing the number of computers in parallel. The speed-up/scaling bottleneck was due to the techniques of decomposing a big computational problem into small sub-problems and the parallel computer architecture were not very well tuned, requiring huge moving around of computational data. The PGSPL method and BPPCA are very well tuned for minimum communication and synchronization requirements, and almost removed the speed-up/scaling bottleneck bringing about the state of “NIRVANA” for parallel computing in general. The BPPCA is scalable in the sense that it can have just two processors to thousands of processors all working in parallel. What followed was proliferation of many/multi-core computers, super computers with massive number crunching capabilities; massively parallel cloud computing machines or data centres. The envelop of technology is being pushed towards utility computing and ultimately putting all automated cloud computing machines (MCAs) in the outer space or on the other planets preferably on the Moon to begin with as per the case made by this inventor in his Canadian patent application #2743882, titled “System of Internet for Information/Data Processing, Storage, and Retrieval” completed on May 28, 2012.

Modern complex Electrical Power Utility System is composed of millions of tiny light bulbs to thousands of huge motors and generators all connected in parallel for operational convenience in the sense that each component from tiny light bulb to huge motor/generator can be individually turned on/off without disturbing rest of the system. The evolution of single generator supplying single light bulb or a group of light bulbs into modern complex Electrical Power Utility System is believed to have taken more than a century.

All automated cloud computing machines can be placed in the outer space or on the other planets preferably on the Moon to begin with for the following reasons.
1. Traditionally, scientists/engineers thought hard about the possibility of generating electricity in the outer space and transmitting on the earth for our use. Huge cloud computing machines consume lot of electricity that can to be generated in the outer space and used there for running cloud computing machines by deploying them in the outer space. Resources required for generating electricity for running cloud computing machines and its impact on environment on the earth can be saved.
2. While machines can live and work almost anywhere, life as we know it cannot be sustained in the outer space unless we learn to live there through technological innovations.
3. So far, Earth is the only planet known to be capable of sustaining life. Even in the desert precious air is available and water can be managed from other areas. Real estate is at premium on earth for life and must not be wasted as far as possible particularly when cloud-computing machines are capable of being deployed in the outer space.
4. The Moon to begin with provides naturally stable platform in the outer space for deployment of huge cloud computing machines. The Moon futuristically can be visualized as knowledge/information/data processing/storage/retrieval warehouse/library for humans on the earth.
5. Peeking deep into the future, the first thing needed is to construct space highway when we are ready to travel deep into the outer space. Cloud computing machines can be used as mile (in terms of space distances) stones on the space highway. Spaceship of the kind of enterprise spaceship of Star Trek could be utilized in almost never ending process of constructing space highway deeper and deeper into the outer space and deploying cloud computing machines as mile stones. Travel on the already constructed space highway could be ‘Travel Light’ because new spaceship will not be required to carry bulky computing machines on board.
6. The concept of cloud computing machines as mile stones or any other similar can be used in making highways/railways on the earth intelligent.

High Performance Computing (HPC) or Super Computing has found its way into mainstream following recent advances in parallel computing technologies particularly influenced by developments of U.S. Pat. No. 7,788,051. Every advance in computing technology has always been followed by increased expectations and demands for enhanced computational power. Recently, HPC has become increasingly pervasive among industries, businesses, and end users.

As per statements in US patent application publication 2012/0331269 titled “Geodesic Massively Parallel Computer”, different modern MCA share similar packaging, construction, and connectivity implementation hierarchy. That is: assemble component ICs onto PCBs, PCBs into racks, racks into cabinets, and cabinets into rooms. Typical communication channels are printed circuits on boards and back-planes, with electrical and fibre optic cabling running over longer distances. Processor-clusters communication in and between cabinets of massively parallel systems is typically cabled, packet switched networks such as Infiniband or Ethernet. So far, all the arrangements have been the use of various physical interconnects networks for multiple processors, multiple banks of shared memory and various other shared resources in MCA. Physical topologies of interconnect networks are typically star, ring, mesh, tours, hypercube, spherical hypercube, and many other variants.

### SUMMARY OF INVENTION

As said before, ICs are networks/circuits in packages interconnecting thousands or millions or billions of discrete electronic components like transistors, diodes, resistors, capacitors etc. depending on level of integration such as SSI, LSI, VLSI using MIs or next-generation evolving CIs. However, integration of discrete electronic components is carried out to create various functional blocks and storage blocks/banks in VLSI such as SoC, SiP, NoC etc. The best approach appears to be scaling of MIs or emerging CIs only to a point of formation of each functional block and/or storage block, and then providing Wireless Interconnect (WLI) for communication among various functional and/or storage blocks. That is to say, intra-functional block uses MIs or emerging CIs, and inter-functional blocks use WLIs. The definition of functional block can vary from designer to designer. For example, a functional block can further be divided into sub-functional blocks and providing MIs or CIs for communication within/intra sub-functional blocks and WLIs for communication among/inter sub-functional blocks along with WLIs among/inter functional blocks. There are two extremes to this approach: at one end there are no WLIs used as per current status of the interconnect technologies, and at the other ideally there are no MIs or CIs used. Hopefully, the other extreme end, wherein interconnect technology that do not use MIs or CIs at all will soon be reached. The WLIs technology has advantages of reconfigurability, system scalability/expandability, and fault tolerance, which are not possible with fixed wire-line MIs or CIs. At the system level fault tolerance can be achieved by software commands to debug and then to eliminate the faulty chips via reconfiguration. Moreover, MIs or CIs techniques using physical “wired” channels for data transport do not resolve the difficult problem of routing the interconnect because they involve consequent time delaying and power consuming switching operations, whereas, WLIs make it possible for every functional block to be able to communicate directly with all others at the speed of light, which is the highest possible. Particularly every processor of MCA can access every bank of shared memory directly with WLIs. Therefore, while allowing for material innovations like CNTs and GNRs for intra-functional CIs, and by using WLIs for inter-functional communication, the present invention attempts to overcome a brick wall by radically different interconnect architectures based on other forms of technology scaling as described in the following. While cut-off switching speed of transistors is expected to be 600 GHz for the next 16 nm technology generation, it may be possible to raise the operational clock frequency of MCAs to 10 GHz and much higher with technology scaling of the present invention along with the use of CIs for intra functional communications.

It is the primary object of the present invention to introduce wireless interconnects for communication among various components of Multiprocessor Computing Apparatus in order to dramatically reduce latency and contention for shared resources for the purpose of parallel processing. MCA comprises 2 or more processors, and sometimes of the order of thousands or millions of processors in case of massively parallel computing apparatus, each processor having private memory, and an access to shared memory divided into memory banks, and also access to other shared resources including input/output devices.

For the purpose of this invention, electro-magnetically shielded and sealed ME also acting as heat sink for the Multiprocessor chips and other heat producing chips without requiring any noise producing cooling fans inside enclosed space that provides means for implementing wireless interconnect for communication among components of MCA. Wireless interconnects can use whole range of both radio and optical frequencies, and use antennas along with transceiver mounted and/or fabricated on components of MCA. Optimized size MCA can be used as building blocks for constructing data centres or cloud computing centres.

### BRIEF DESCRIPTION OF DRAWINGS

FIG. 1 is the prior art Parallel Computer Architecture with private local memory for each processor and a shared memory and Input/Output devices shared among all processors.

FIG. 2a is the schematic block diagram of typical Multiprocessor Integrated Circuit (IC) 10a chip that contains and symbolically shows multiprocessors and banks of shared memory along with embedded antenna for each.

FIG. 2b is the schematic block diagram of typical Multiprocessor IC 10b chip that contains only multiprocessors along with embedded antenna for each.

FIG. 2c is the schematic block diagram of typical memory IC 10c chip that contains only banks of shared memory along with embedded antenna for each bank.

FIG. 3a is the schematic block diagram of IC chips 10a mounted on typical PCB 100a.

FIG. 3b is the schematic block diagram of IC chips 10b mounted on typical PCB 100b.

FIG. 3c is the schematic block diagram of IC chips 10c mounted on typical PCB 100c.

FIG. 3d is the schematic block diagram of IC chips 10b and 10c mounted on typical PCB 100d.

FIG. 3e is the schematic block diagram of IC chips 10b and 10c mounted on typical PCB 100e.

FIG. 4a is the schematic layout of PCBs 100a mounted on metallic surface 1000a that acts as heat sink and forms one side of Metallic Enclosure (ME) that houses MCA, or an apparatus or equipment, or a device.

FIG. 4b is the schematic layout of PCBs 100b mounted on metallic surface 1000b that acts as heat sink and forms one side of ME that houses MCA, or an apparatus or equipment, or a device.

FIG. 4c is the schematic layout of PCBs 100c mounted on metallic surface 1000c that acts as heat sink and forms one side of enclosure of MC that houses MCA, or an apparatus or equipment, or a device.

FIG. 4d is the schematic layout of PCBs 100b and 100c mounted alternately on metallic surface 1000d that acts as heat sink and forms one side of ME that houses MCA, or an apparatus or equipment, or a device.

FIG. 4e is the schematic layout of PCBs 100b and 100c mounted on metallic surface 1000e that acts as heat sink and forms one side of ME that houses MCA, or an apparatus or equipment, or a device.

FIG. 5a is the cubical ME of the same dimensions on all sides, and dimensions increase and decrease for increased or decreased size of the parallel MCA, or an apparatus or equipment, or a device.

FIG. 5b is the rectangular ME whose dimensions increase and decrease for increased or decreased size of the parallel MCA, or an apparatus or equipment, or a device.

FIG. 5c is the cylindrical ME whose height is equal to its diameter, and diameter increase and decrease for increased or decreased size of the parallel MCA, or an apparatus or equipment, or a device.

FIG. 5d is the cylindrical ME whose dimensions increase and decrease for increased or decreased size of the parallel MCA, or an apparatus or equipment, or a device.

### DESCRIPTION OF PREFERRED EMBODIMENT

Present invention is about putting a MCA or any other similar apparatus/equipment/device into an electro-magnetically shielded and sealed Metallic Enclosure (ME) or Container, and using wireless means for communication among its components. Aluminium, Copper, or any alloy metal that is good conductor of both heat and electricity can be used in making ME. The ME also acts as heat sink for component ICs of the MCA, or an apparatus or equipment, or a device, and if required it can be corrugated and/or finned on the outside to increase surface area for heat dissipation. The ME of MCA, or an apparatus or equipment, or a device, can also be made dust proof, sound proof, and water proof so that it can be placed under water in a sea or a lake or a river preferably closure to the mouth of river where water is clean pristine and naturally flowing in order to save electricity expended in cooling MCA particularly when it constitutes data centre or cloud computing centre. As per statements in US patent application publication # US 2012/0331269 titled “Geodesic Massively Parallel Computer”: High-performance computer systems consume large amounts of electrical power, which gets dissipated a heat. Typically, a similar amount of energy is used by refrigeration as the computer proper. That means, by putting MCAs constituting data/cloud centres under water particularly close to the mouth of a river can save almost 50% of electrical power used in running data/cloud centre.

ME being electro-magnetically shielded and sealed whole range of radio frequency and optical frequencies are available for wireless means of communication among components of an apparatus or a device enclosed. A designer can use different range of frequencies for different purposes of communication, or different frequency ranges for different purposes of communication inside electro-magnetically sealed ME for different products can be standardised by industry associations. Inside of ME is either vacuum or filled with clear purified air without any suspended particles for efficient and reliable wireless communication. For mitigation of the problem of reflections and multi paths, inside surface of ME is made rough enough to cause much of scattering and less of reflection of impinging electromagnetic wave. Also all surfaces of PCBs and components mounted on them are made rough enough to mitigate the problem of reflection and multi path. These measures are taken in addition to setting multi path equalization value on transmitters to effectively cancel the reflections and multi-paths. Transmitter equalization significantly reduces ISI caused by dense multi-path signals.

The present invention provides methods for massively parallel MCA implementation where best and worst-case neighbour-to-neighbour distances can be short and similar, which facilitates broadcast of data or instructions with high performance and substantially equal timing. In every sense, the invention is as general purpose as other parallel computers and is eminently scalable in terms of size, configuration, and performance. It lands itself well to a broad variety of apparatus or devices that can be enclosed in electro-magnetically shielded and sealed metallic enclosure and use wireless interconnect for communication among and/or within component ICs and other circuits.

Cubical and cylindrical with height equal to diameter MEs allow maximum distance traveled by wireless communication signals of data, instruction, control to be approximately the same. However, MEs can be made of shape that permits fastest possible communications between processors and banks of shared memory for high-bandwidth data rates communications. Other slower low-bandwidth data rate communications such as control signals can take place over longer distances. For example, processors PCBs and banks of shared memory PCBs can be mounted on longer 4-metalic sides of rectangular ME, and control and other circuit PCBs can be mounted on top and bottom 2-metalic sides of rectangular ME, and there are many such other possibilities. Because of high-bandwidth data rates communications requirements between processors and banks of shared memory, different possible processors and banks of memory layouts are given in figures. However, a designer can appropriately place ICs for functions of other purposes among processors and banks of memory layouts or they can be placed on separate metallic inside surface of ME.

Various possible arrangements or layouts of components within ICs, ICs on PCBs and PCBs on metallic surfaces of ME will now be described using various figures.

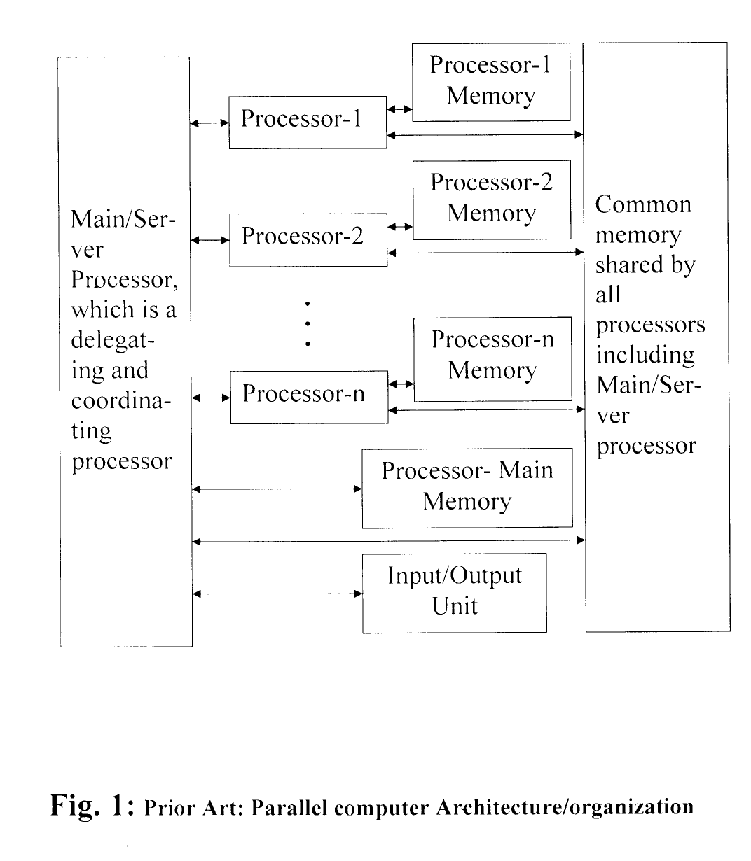

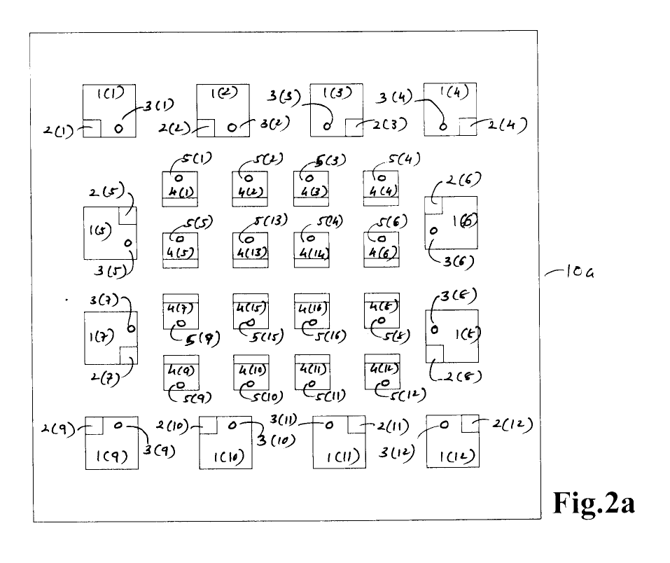

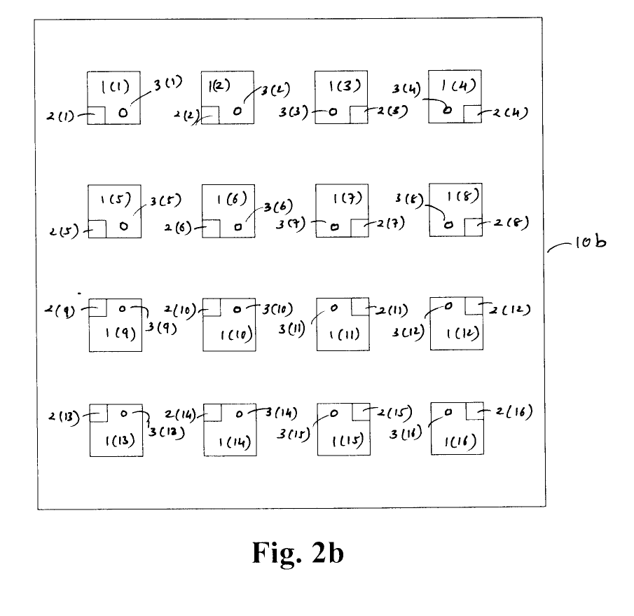

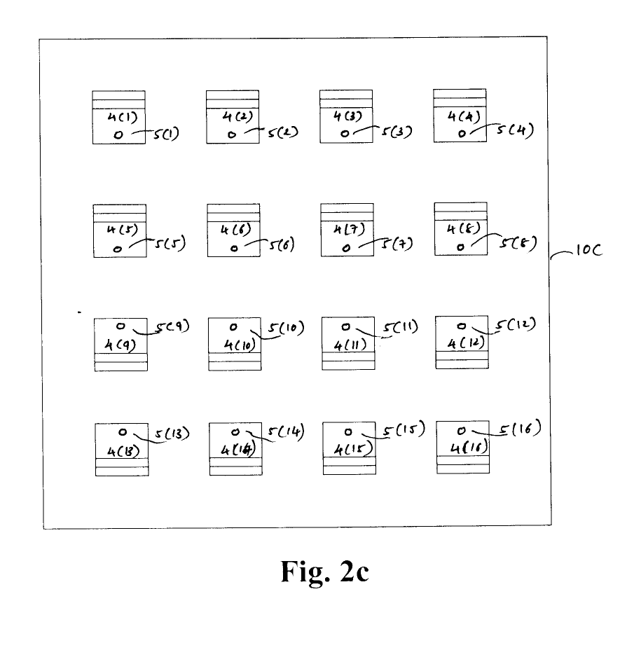

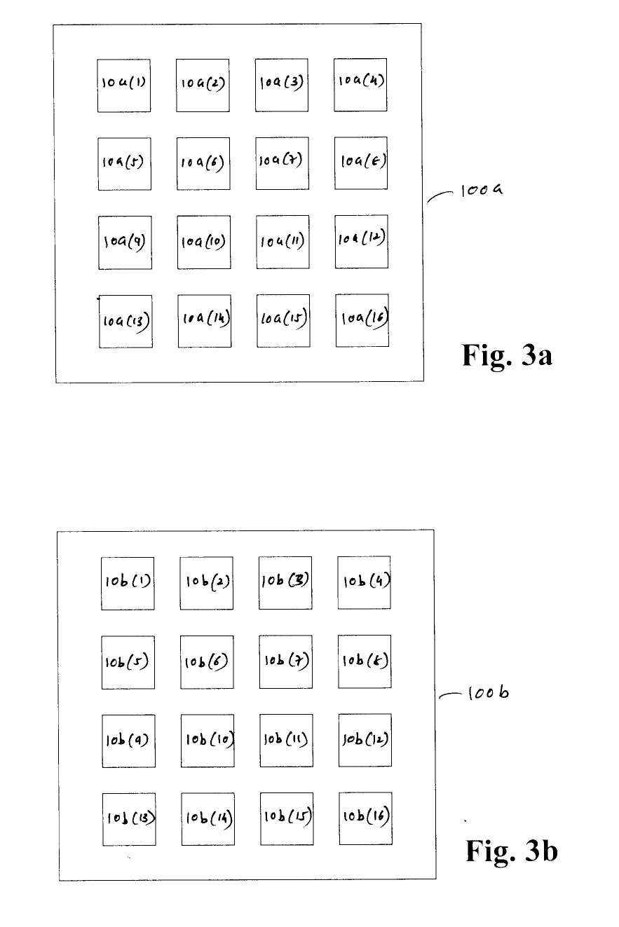

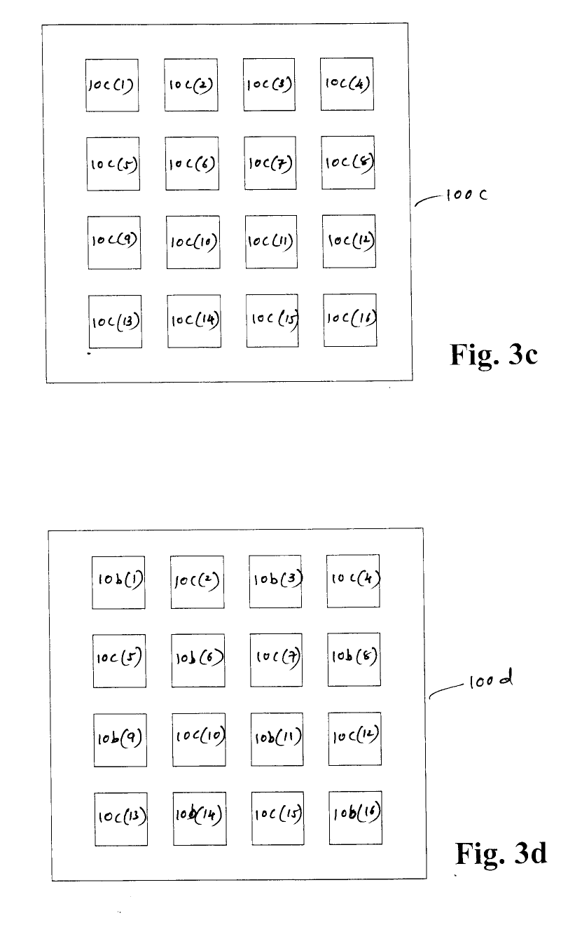

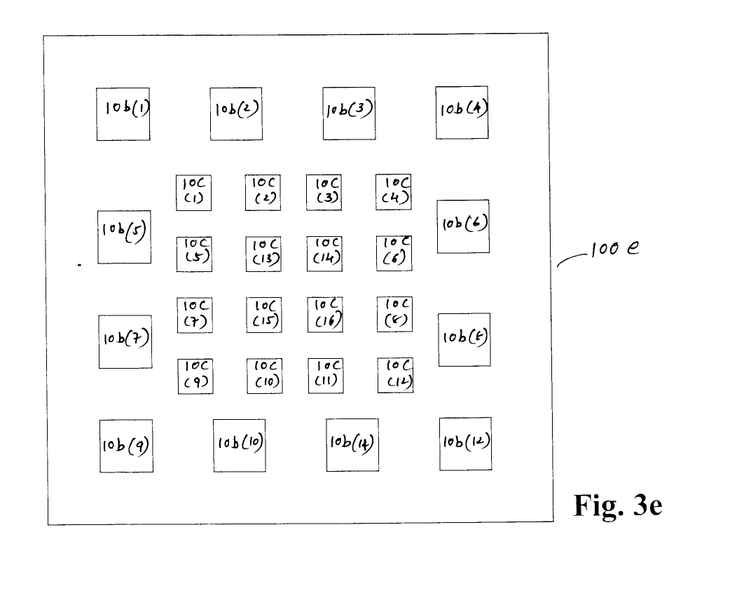

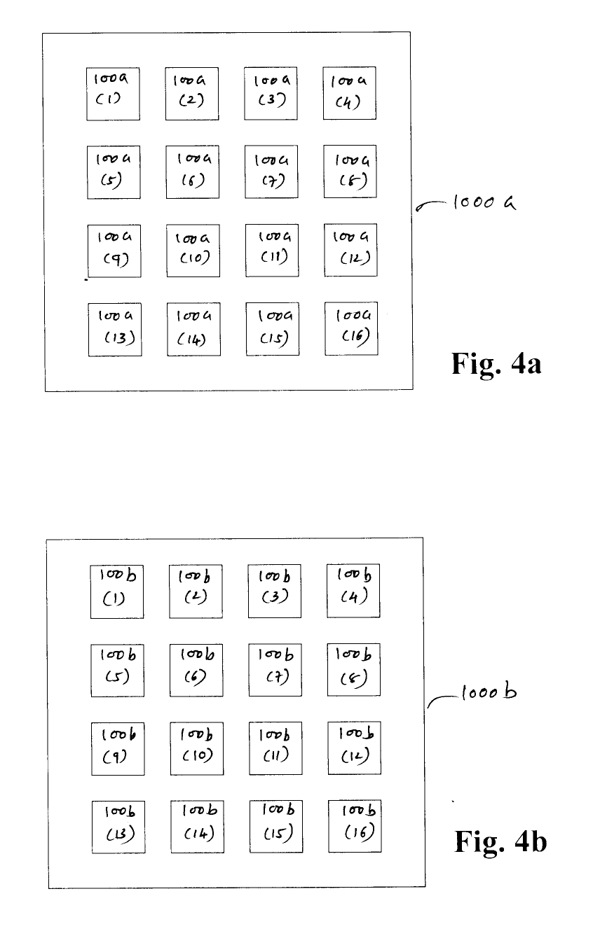

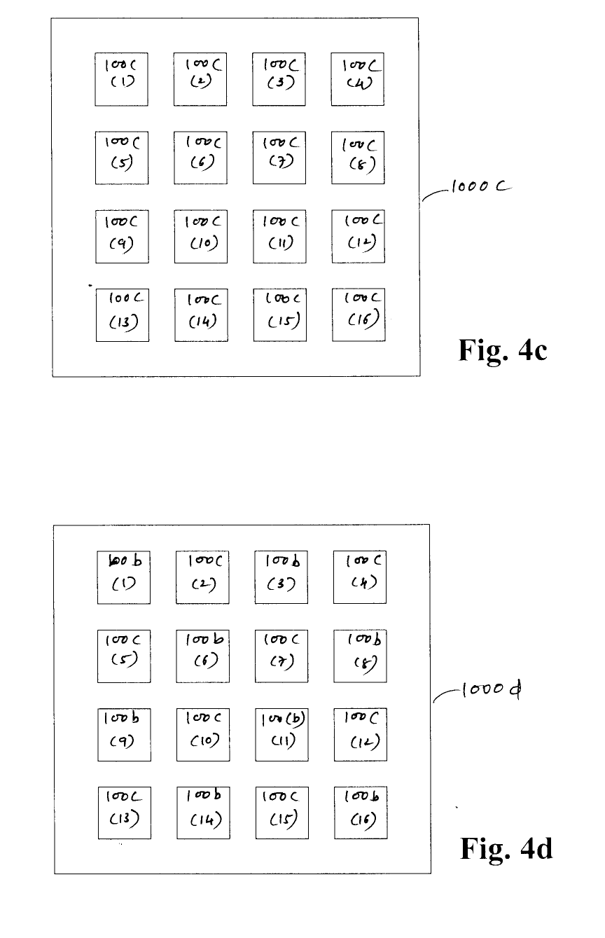

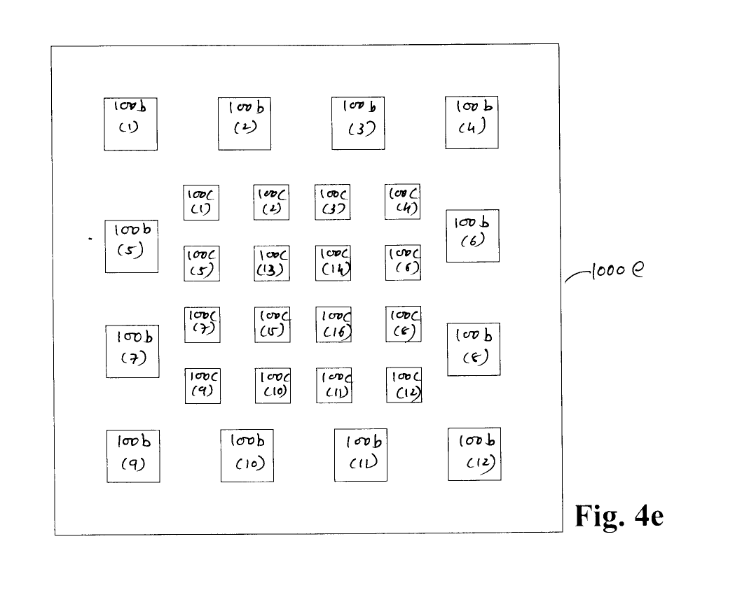

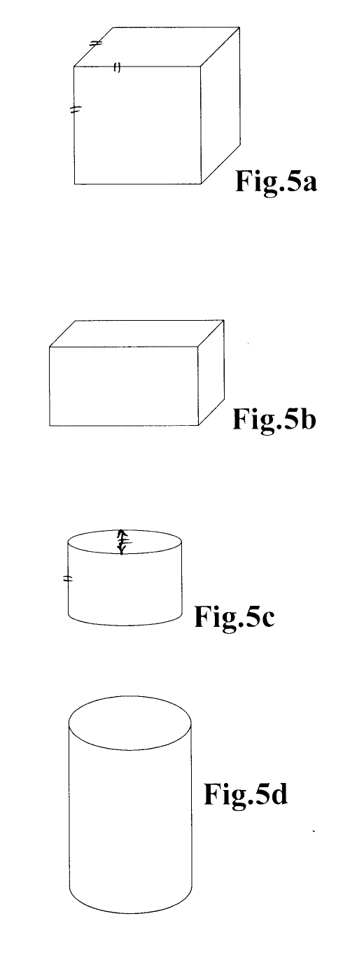

FIG. 1 is the best possible parallel computer architecture originally claimed in U.S. Pat. No. 7,788,051 that marked beginning of the new era of computer technology. The same architecture is depicted into FIG. 2a without any connecting lines shown and without depicting Input/Output unit. In FIG. 2a IC chip 10a contains say 12 processors 1(1), 1(2), . . . , 1(12) each having its private local memory 2(1), 2(2), . . . , 2(12) and embedded antenna 3(1), 3(2), . . . , 3(12) for sending/receiving information/data to/from among themselves and other components of MCA. 4(1), 4(2), . . . , 4(16) are memory banks shared among all processors 1(1), 1(2), . . . , 1(12). 5(1), 5(2), . . . , 5(16) are embed antenna on each memory bank of shared memory. FIG. 2b is of IC chip 10b containing say 16 only processors 1(1), 1(2), . . . , 1(16) along with their private memories 2s and embedded antennas 3s. FIG. 2c of IC chip 10c containing say 16 only memory banks 4(1), 4(2), . . . , 4(16) of shared memory along with their embedded antennas 5s. Number of processors and/or number of memory banks in each IC chip varies depending on level of integration or the size of IC. FIG. 3a is the schematic diagram of PCB on which mounted are the IC chips 10a(1), 10a(2), . . . , 10a(16). FIG. 3b is the schematic diagram of PCB on which mounted are the IC chips 10b(1), 10b(2), . . . , 10b(16). FIG. 3c is the schematic diagram of PCB on which mounted are the IC chips 10c(1), 10c(2), . . . , 10c(16). FIG. 3d is the schematic diagram of PCB on which mounted are the IC chips 10b(1), 10c(2), 10b(3), 10c(4), . . . , 10c(16). FIG. 3e is the schematic diagram of PCB on which mounted are the IC chips 10b(1), 10b(2), . . . , 10b(12) and the IC chips 10c(1), 10c(2), . . . , 10c(16). PCBs, in addition to mounted ICs, may also contain other discrete components as required. The only printed circuits are those for supplying power to different IC chips and interconnects for discrete components mounted on PCB. Sometimes lines carrying control signals are also printed on circuit boards on which ICs are mounted, and antennas are used only for wireless transmittal of data signals. FIG. 4a, FIG. 4b, FIG. 4c, FIG. 4d, and FIG. 4e are the schematic layouts of PCBs 100a(1), 100a(2), . . . , 100a(16); 100b(1), 100b(2), . . . , 100b(16); 100c(1), 100c(2), . . . , 100c(16); 100b(1), 100c(2), 100b(3), 100c(4), . . . , 100c(16); and 100b(1), 100b(2), . . . , 100b(12) and 100c(1), 100c(2), . . . , 100c(16); mounted respectively on metallic surfaces 1000a, 1000b, 1000c, 1000d, and 1000e that acts as heat sink and forms one side of enclosure of ME or portion of curved surfaces of cylindrical or spherical ME that houses MCA. FIGS. 2 to 4 are for depicting different possible layouts of different functional blocks inside each of ICs, different ICs mounted on PCBs, and different PCBs mounted on inside of ME sides. FIGS. 5a, 5b, 5c, and 5d are different possible MEs other than spherical, and other rectangular shapes.

Single IC chip can contain say, 5, 10, 100, . . . etc processors along with local private memory of each processor depending on SSI, LSI, or VLSI chip, and depending on size of MCA that is being built. MCA of few processors say, 10 could be housed in small ME, and massively parallel MCA of 1000s and 1000s of processors requires huge cubical, spherical, cylindrical, or rectangular ME. The length of all sides of cubical is the same, and height of cylindrical metallic housing is the same as its diameter, however, rectangular and cylindrical MEs of other dimensions can also be used. Between a processor and its private local memory is a wired connection, however, they can also be connected by intra-chip WLIs. Communication among processors and shared resources is wireless through embedded antenna on each processor and shared memory bank and other shared resources like input/output. Memory bank is made up of a group of addressable memory locations. Usual wired connections are provided among the group of addressable memory locations contained in each memory bank, however, they can be intra-chip WLIs. Ideally, the smallest memory bank is made up of a single addressable memory location. Similarly all shared input/output devices are also embedded with antennas for wireless communication with other components of MCA. Shared memory can be on the same IC chip of multiprocessors or it can be a separate IC chip in itself. IC chips can be arranged on PCB in different possible arrangements depicted in FIG. 3a, FIG. 3b and FIG. 3c, FIG. 3d, FIG. 3e. PCB without many wired connections can accommodate many multiprocessor IC chips and shared memory IC chips. This helps achieve miniaturization of MCA. Other IC chips for inputs/outputs and IC chips that facilitate wireless communications are added on PCBs as required. The only wired connections required on PCBs are for supplying Electrical Power to various IC chips, and wiring traces for other discrete components as required.

This invention is about making available the whole range of radio, microwave, and optical frequencies for wireless preferably Line-of-sight (LOS) all-to-all communication among components of an apparatus or an equipment or a device by enclosing it in an electro-magnetically shielded and sealed ME that also acts as heat-sink for heat producing components like microprocessors. In other words, an apparatus or an equipment or a device enclosed in a dust-proofed and electro-magnetically shielded and sealed ME making available the whole range of radio, microwave, and optical frequencies for wireless direct all-to-all communication among its components, and ME also acts as an extended heat-sink for heat producing components attached to it from inside, wherein ME is either vacuumed or filled with clean air without any suspended particles for efficient and reliable communication.

In another embodiment of this invention an apparatus can be built that can eliminate routing apparatus/system that requires time delaying and power consuming buffering and switching operations in packet switched or circuit switched communication systems. Such an apparatus when replaces each of the routing apparatus/system in a communication system, information/data can flow without any hindrances to destinations. Hasn't this inventor become a great artist now that he is able to sing: let it flow, let it flow, let it flow . . . ?

### FURTHER EMBODIMENTS

Specific embodiments have been used to describe the invention. However, numerous modifications are possible as would be recognized by one skilled in the art. For instance, the descriptions in the above may make reference to specific ideal layout of components of wireless interconnects, it will be appreciated that various other arrangements could be implemented using any combination of hardware and/or software.

Although, the invention has been described with respect to specific embodiments, it will be appreciated that the invention is intended to cover all modifications and equivalents within the scope of the following claims.

1. A Multiprocessor Computing Apparatus (MCA) comprising components of multiprocessors each with private local memory, banks of shared memory, interface circuits of peripheral components and input/output devices, and wireless means of communication among all the said components mounted on Printed Circuit Boards (PCBs), and PCBs are mounted on walls of Electro-magnetically Shielded and sealed Metallic Enclosure (ME) that is good conductor of both heat and electricity.

2. MCA as defined in claim-1, wherein wireless means of communication comprises transceivers and antenna for each of functional units that are each of processors, each banks of shared memory, each of interface circuits of input/output devices and peripheral components.

3. MCA as defined in claim-2, wherein each functional unit is divided into sub-functional units that use Metallic Interconnects (MIs) or Carbon Interconnects (CIs) or Wireless Interconnects (WLIs) for communication among/inter sub-functional units.

4. MCA as defined in claim-3, wherein each sub-functional unit is comprised of discrete electronic components of transistors, diodes, resistors, capacitors, inductors that are interconnected by MIs or CIs.

5. MCA as defined in claim-1, wherein ME acts as heat-sink for all heat producing Integrated Circuits (ICs) including multiprocessor ICs that are attached to ME.

6. MCA as defined in claim-1, wherein outside surface of ME is corrugated or finned for increasing heat dissipation surface area, and there are no cooling fans inside of ME.

7. MCA as defined in claim-1, wherein ME is made water proof and placed under water in a sea, or a lake, or a river preferably closure to the mouth of a river where water is clean, pristine, and naturally flowing.

8. MCA as defined in claim-1, wherein ME is made dust proof and inside of ME is either vacuumed or filled with clean air without any suspended particles for efficient and reliable wireless communications.

9. MCA as defined in claim-8, wherein inside surfaces including surfaces of mounted PCBs and mounted components on PCBs are made rough to cause much of scattering and less of reflection of impinging electromagnetic waves.

10. An apparatus or an equipment or a device enclosed in a dust-proofed and electro-magnetically shielded and sealed ME making available the whole range of radio, microwave, and optical frequencies for wireless direct all-to-all communication among its components, and ME also acts as an extended heat-sink for heat producing components attached to it from inside, wherein ME is either vacuumed or filled with clean air without any suspended particles for efficient and reliable communication.
